(19) United States
(12) Patent Application Publication
(10) Pub. No.: US 2015/0165613 A1
(43) Pub. Date: Jun. 18, 2015

(54) CONNECTION FIXED DEVICE FOR HOST AND ACCESSORY OF SWING TOOLS

(71) Applicant: Xiao-Rong Li, Taizhou (CH)

(72) Inventor: Xiao-Rong Li, Taizhou (CH)

(73) Assignee: Zhejiang Rongpeng Air Tools Co., Ltd., Taizhou (CH)

(21) Appl. No.: 14/207,646

(22) Filed: Mar. 13, 2014

(30) Foreign Application Priority Data
Dec. 17, 2013 (CH) 201320831046.9

(51) Int. Cl. B25F 3/00

(52) U.S. Cl. CPC B25F 3/00

(57) ABSTRACT

A connection fixed device for host and accessory of swing tools includes an output shaft in the host and a working head arranged at the top part thereof, characterized in that: a regular polygonal protruding block is arranged in an axis core of upper surface; a plurality of stoppers are arranged evenly along the circumferential direction of the top of a connector and regular polygonal slots corresponding to the protruding block in the bottom of the connector; the number of sides of said regular polygonal slots is great than or equal to that of the protruding block; said stopper of the working head, the protruding block and the connector are all matched. The protruding block of the utility model is designed in regular polygon which can be matched with most of working heads, even some have special shape of coupling holes, which can be coupled with the connector in advance and then with the output shift, it is very convenient to work.

### FIELD OF THE INVENTION

The present invention relates to a connection fixed device for host and accessory of swing tools

### BACKGROUND OF THE INVENTION

At present, multifunction swing tools are widely used for decoration, furniture making and other industries, the operation principle is that a working head arranged in an output shift of the host do high frequency and small angle swing around the output shift. According to different demand, it can be used respectively for sawed, cut, grinded, scraped by changed different working heads. But the working head is only matched with the same type of the host of the swing tool in the market, which cannot used in other different type of host and easily damaged accessory, once on wear failure, only option is to buy the same type of working head. If using different functions of the work head, you are need to buy the other type of the host for supporting the use on. Therefore, the general swing tools for users not only caused many purchase troubles, but also increased the costs.

### SUMMARY OF THE INVENTION

The technic proposal of the utility model is that:

The utility model discloses a connection fixed device for host and accessory of swing tools includes an output shaft in the host and a working head arranged at the top part thereof, characterized in that: a regular polygonal protruding block is arranged an axis core of upper surface; a plurality of stoppers are arranged evenly along the circumferential direction of the top of a connector and regular polygonal slots corresponding to the protruding block in the bottom of the connector; the number of sides of said regular polygonal slots is great than or equal to that of the protruding block; said stopper of the working head, the protruding block and the connector are all matched.

Wherein said polygonal protruding block is a regular hexagon; the polygonal slot is a regular dodecagon and is provided with a semicircle hole in each outer corners; the height of the protruding block is less than or equal to the depth of the slot.

The number of the stopper is twelve and square; a plurality of limit grooves corresponding to the stopper are arranged evenly along the circumferential direction of the bottom of the connector.

The upper surface of the output shaft is provided with a plurality of recesses, a screw hole is arranged in an axis core of the output shaft; an opening corresponding to the screw hole is located at the center of the connector.

The utility model has the advantages of that:

Compared with prior arts, the protruding block of the utility model is designed in regular polygon which can be matched with most of working heads, therefore, the host of swing tool of the utility model can also be matched in most types of working head in the market, even some have special shape of coupling holes, which can be coupled with the connector in advance and then with the output shift, so it can be used directly without purchasing other working head and host, the utility model is not troublesome, and the money is also saved.

### BRIEF DESCRIPTION OF THE DRAWINGS

FIG. 1 is a schematic view of the connection fixed device for host and accessory of swing tools to the present invention.

FIG. 2 is a schematic perspective view of an angle of connector.

### DETAILED DESCRIPTION OF THE PREFERRED EMBODIMENT

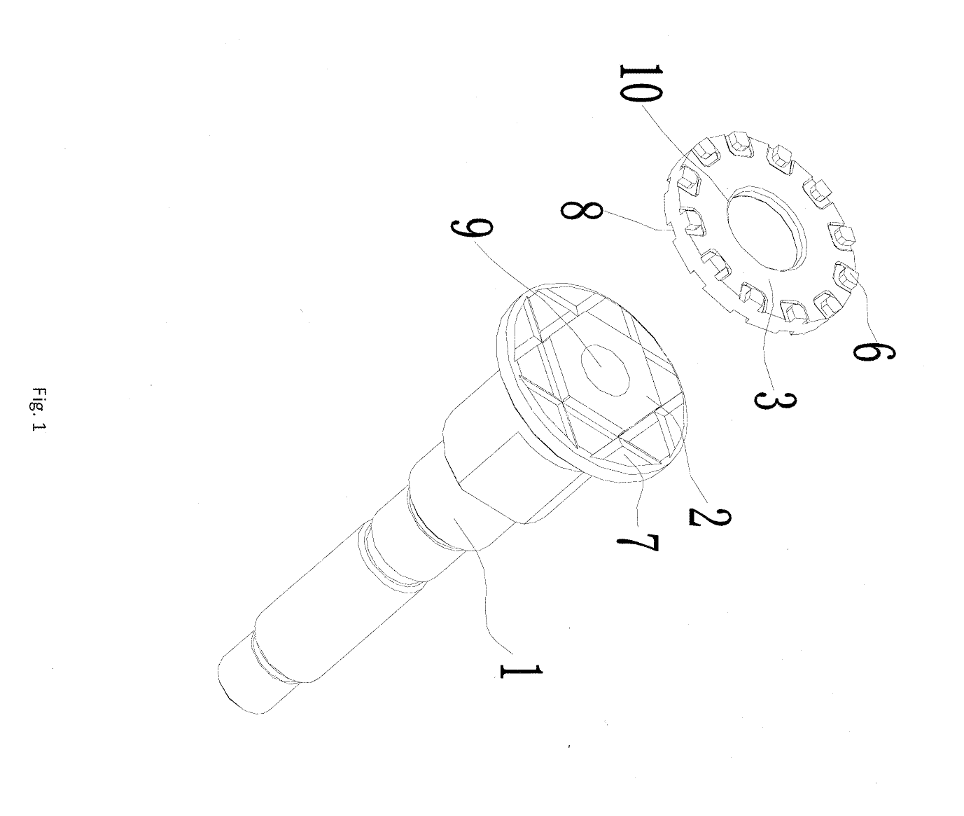

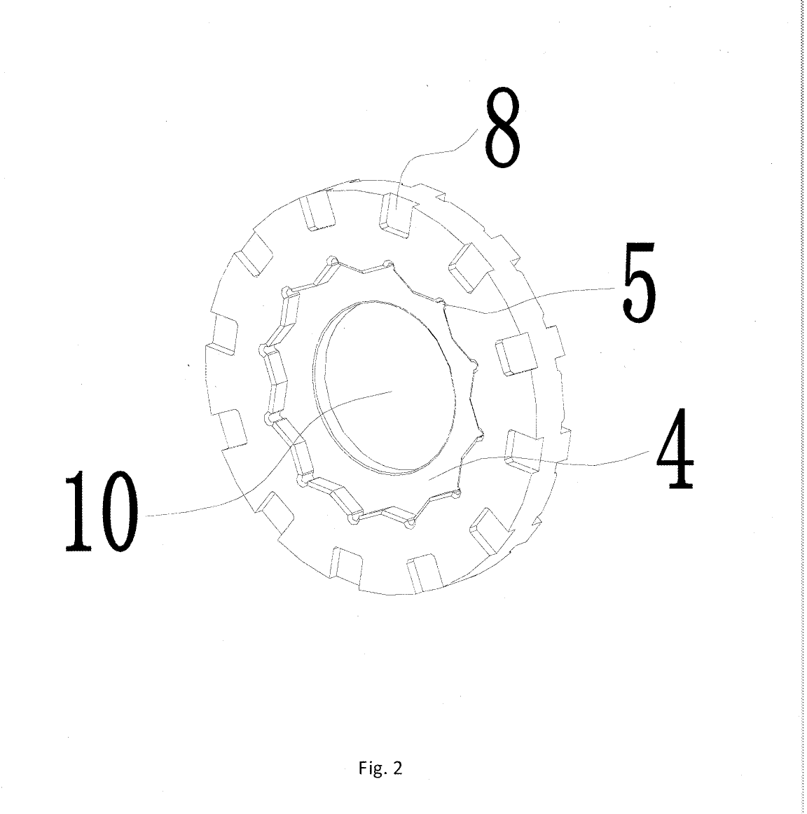

Referring to FIG. 1 and FIG. 2, the utility model discloses a connection fixed device for host and accessory of swing tools includes an output shaft (1) in the host and a working head arranged at the top part thereof, characterized in that: a regular polygonal protruding block (2) is arranged an axis core of upper surface; a plurality of stoppers (6) are arranged evenly along the circumferential direction of the top of a connector (3) and regular polygonal slots (4) corresponding to the protruding block (2) in the bottom of the connector (3); the number of sides of said regular polygonal slots (4) is great than or equal to that of the protruding block (2); said stopper (6) of the working head, the protruding block (2) and the connector (3) are all matched.

Wherein said polygonal protruding block (2) is a regular hexagon; the polygonal slot (4) is a regular dodecagon and is provided with a semicircle hole (5) in each outer corners which can avoid damaged by friction between the corner of the protruding block (2) and the slots (4) when both are connected to each other; both the protruding block (2) and the slots (4) are regular polygon, when the working head is connected with the protruding block (2), the angle can be changed and the numbers of angle are the same as the sides thereof, and which can also be applied when the working head is coupled with the connector (3), based on those reasons, the regular polygonal protruding block (2) can be greater than hexagon, such as octagon, which can increase the numbers of the angle for meeting different needs of work; the height of the protruding block (2) is less than or equal to the depth of the slot (4) so that the protruding block (2) is always arranged inside the slot (4), and more stable for connection between the output shift and the connector (3).

the protruding block (2) of the utility model is designed in regular polygon which can be matched with most of working heads, therefore, the host of swing tool of the utility model can also be matched in most types of working head in the market, even some have special shape of coupling holes, which can be coupled with the connector (3) of the stopper (6) in advance and then with the output shift (1), so it can be used directly without purchasing other working head and host, the utility model is not troublesome, and the money is also saved.

The number of the stopper (6) is twelve and square; a plurality of limit grooves (8) corresponding to the stopper (6) are arranged evenly along the circumferential direction of the bottom of the connector (6). The function of the stopper (6) is for adapting special shape of working head of coupling hole and the limit groove (8) is for installation structure of the output shift (1), the special coupling holes of working head are mostly limiting holes arranged evenly around circumferential direction in the market, so that the connector (3) of the utility model can be adapted for more types of working head and the number and the shape of the stopper (6) can be changeable in accordance with actual needs, both the connector (3) and accessory of the working head are also can be designed for matching other structures in the most of the work and the same as the limit groove (8) below connector or the slot (4) for output shift.

The upper surface of the output shaft (1) is provided with a plurality of recesses (7); if the upper surface of the output is flat, which can be enough friction with the working head, but it increases the cost of production. Therefore, the recesses not only increase more friction, but also easy to operate in angle gouging; a screw hole (9) arranged in an axis core of the output shift; an opening (10) corresponding to the screw hole is located at the center of the connector (3); when coupled with working head and output shift, just fix an screw into the screw hole (9) of the output shift through working head, if a working head is arranged on the connector (3), fix the connector (3) on the output shift (1) in advance and then fix an screw into the screw hole (9) through the working head, the connector and the opening (10).

The connector (3) of the utility model increases hardness by hot treatment, it makes not easy wear failure and has a longer using-time.

I claim:

1. A connection fixed device for host and accessory of swing tools includes an output shaft in the host and a working head arranged at the top part thereof, characterized in that: a regular polygonal protruding block is arranged in an axis core of upper surface; a plurality of stoppers are arranged evenly along the circumferential direction of the top of a connector and regular polygonal slots corresponding to the protruding block in the bottom of the connector; the number of sides of said regular polygonal slots is great than or equal to that of the protruding block; said stopper of the working head, the protruding block and the connector are all matched.

2. The connection fixed device for host and accessory of swing tools as claimed in claim 1, characterized in that: wherein said polygonal protruding block is a regular hexagon; the polygonal slot is a regular dodecagon and is provided with a semicircle hole in each outer corners; the height of the protruding block is less than or equal to the depth of the slot.

3. The connection fixed device for host and accessory of swing tools as claimed in claim 1, characterized in that: the number of the stopper is twelve and square; a plurality of limit grooves corresponding to the stopper are arranged evenly along the circumferential direction of the bottom of the connector.

4. The connection fixed device for host and accessory of swing tools as claimed in claim 1, characterized in that: the upper surface of the output shaft is provided with a plurality of recesses, a screw hole is arranged in an axis core of the output shaft; an opening corresponding to the screw hole is located at the center of the connector.
